(19) United States
(12) Patent Application Publication
(10) Pub. No.: US 2023/0144048 A1
(43) Pub. Date: May 11, 2023

(54) MEDICAL PRESSURE SENSITIVE ADHESIVES FREE OF POLAR GROUPS

(71) Applicant: 3M INNOVATIVE PROPERTIES COMPANY, St. Paul, MN (US)

(72) Inventors: Lin Chen, St. Paul, MN (US); Stefan H. Gryska, Woodbury, MN (US); Dong-Wei Zhu, North Oaks, MN (US); Bret W. Ludwig, Oakdale, MN (US); Matthew J. Bongers, Minneapolis, MN (US); Ying Zhang, Woodbury, MN (US)

(21) Appl. No.: 17/913,495

(22) PCT Filed: Mar. 18, 2021
(86) PCT No.: PCT/IB2021/052296

§ 371 Date: Sep. 22, 2022

Related U.S. Application Data
(60) Provisional application No. 62/994,583, filed on Mar. 25, 2020.

(51) Int. Cl. C09J 133/10; C09J 7/35; C09J 11/06

(52) U.S. Cl. CPC C09J 133/10; C09J 7/35; C09J 11/06; C09J 2433/00

(57) ABSTRACT

Crosslinked (meth)acrylate-based pressure sensitive adhesives are capable of attachment to mammalian skin for at least 10 days. The crosslinked adhesive composition includes a crosslinked (meth)acrylate-based copolymer free from polar groups, and a hydrogenated hydrocarbon tackifier resin. The crosslinked adhesive composition is prepared by photocrosslinking a hot melt processable blend of a (meth)acrylate copolymer and a hydrogenated hydrocarbon tackifier resin. The (meth)acrylate copolymer is the reaction product of an alkyl (meth)acrylate monomer with alkyl groups of 4-22 carbon atoms and are free of polar groups, and a copolymerizable photocrosslinker.

### FIELD OF THE DISCLOSURE

This disclosure relates to (meth)acrylate-based pressure sensitive adhesives that may be used to form adhesive articles, such as tapes and other medical articles useful in medical applications.

### BACKGROUND

A wide range of adhesive articles are used in medical applications. These adhesive articles include gels used to attach electrodes and other sensing devices to the skin of a patient, a wide range of tapes to secure medical devices to a patient, and adhesive dressings used to cover and protect wounds.

Many of the adhesive articles use pressure sensitive adhesives. Pressure sensitive adhesives are well known to one of ordinary skill in the art to possess certain properties at room temperature including the following: (1) aggressive and permanent tack, (2) adherence with no more than finger pressure, (3) sufficient ability to hold onto an adherend, and (4) sufficient cohesive strength to be removed cleanly from the adherend. Materials that have been found to function well as pressure sensitive adhesives are polymers designed and formulated to exhibit the requisite viscoelastic properties resulting in a desired balance of tack, peel adhesion, and shear strength. The most commonly used polymers for preparation of pressure sensitive adhesives are natural rubber, synthetic rubbers (e.g., styrene/butadiene copolymers (SBR) and styrene/isoprene/styrene (SIS) block copolymers), various (meth)acrylate (e.g., acrylate and methacrylate) copolymers, and silicones.

### SUMMARY

Disclosed herein are crosslinked (meth)acrylate-based pressure sensitive adhesives that may be used to form adhesive articles, such as tapes and other medical articles useful in medical applications. In some embodiments, the crosslinked adhesive composition comprises a crosslinked (meth)acrylate-based copolymer free from polar groups, and a hydrogenated hydrocarbon tackifier resin. The crosslinked adhesive composition is the product of a hot melt processable blend of a (meth)acrylate copolymer and a hydrogenated hydrocarbon tackifier resin. The (meth)acrylate copolymer is the reaction product of a reaction mixture comprising at least one alkyl (meth)acrylate monomer with alkyl groups comprising 4-22 carbon atoms and are free of polar groups, and a co-polymerizable photocrosslinker. The hot melt processed blend has been photocrosslinked.

Also disclosed are adhesive articles, where the adhesive articles comprise a substrate comprising a first major surface and a second major surface and a crosslinked adhesive layer with a first major surface and a second major surface where the first major surface of the adhesive layer is at least partially disposed on the second major surface of the substrate. The crosslinked adhesive layer comprises a crosslinked adhesive composition as described above. The crosslinked adhesive composition comprises a crosslinked (meth)acrylate-based copolymer free from polar groups and a hydrogenated hydrocarbon tackifier resin. The crosslinked adhesive composition is the product of a hot melt processable blend of a (meth)acrylate copolymer and a hydrogenated hydrocarbon tackifier resin. The (meth)acrylate copolymer comprises the reaction product of a reaction mixture comprising at least one alkyl (meth)acrylate monomer with alkyl groups comprising 4-22 carbon atoms and are free of polar groups, and a co-polymerizable photocrosslinker. The hot melt processed blend has been photocrosslinked. The adhesive article is capable of attachment to mammalian skin for at least 10 days.

### DETAILED DESCRIPTION

The use of adhesive products in the medical industry has long been prevalent and is increasing. However, while adhesives and adhesive articles have shown themselves to be very useful for medical applications, there are also issues in the use of adhesives and adhesive articles. In particular, the desired properties for adhesives are often contradictory. For example, it is desirable that the adhesives have high adhesion to an array of surfaces, including human skin, and yet the adhesive also is desirably removable without damaging the skin. Additionally, medical articles are being worn for longer periods of time, needing to remain adhered and yet need to be removable without damaging the skin or leaving residue.

Medical adhesive-related skin injury (MARSI) has a significant negative impact on patient safety. Skin injury related to medical adhesive usage is a prevalent but under-recognized complication that occurs across all care settings and among all age groups. In addition, treating skin damage is costly in terms of service provision, time, and additional treatments and supplies.

Skin Injury occurs when the superficial layers of the skin are removed along with the medical adhesive product, which not only affects skin integrity but can cause pain and the risk of infection, increase wound size, and delay healing, all of which reduce patients’ quality of life.

Medical adhesive tape can be simply defined as a pressure-sensitive adhesive and a backing that acts as a carrier for the adhesive. The US Food and Drug Administration more specifically defines a medical adhesive tape or adhesive bandage as “a device intended for medical purposes that consists of a strip of fabric material or plastic, coated on one side with an adhesive, and may include a pad of surgical dressing without a disinfectant. The device is used to cover and protect wounds, to hold together the skin edges of a wound, to support an injured part of the body, or to secure objects to the skin.”

While the pathophysiology of MARSI is only partially understood. Skin injury results when the skin to adhesive attachment is stronger than skin cell to skin cell attachment. When adhesive strength exceeds the strength of skin cell to skin cell interactions, cohesive failure occurs within the skin cell layer.

The intrinsic characteristics of all components of an adhesive product must then be taken into account to address these factors that may lead to MARSI. Properties of the adhesive to be considered include cohesiveness over time and the corresponding adhesion strength; properties of the tape/backing/dressing to be considered include breathability, stretch, conformability, flexibility, and strength.

The widespread use of adhesives in medical applications has led to the development of adhesives and adhesive articles that are gentle to the skin. Some of these adhesives are pressure sensitive adhesives. The application of pressure sensitive adhesives, including acrylate-based and silicone-based pressure sensitive adhesives, for adhering to skin is known in the art and many examples are commercially available.

Among the classes of adhesive materials that have found widespread use as pressure sensitive adhesives are (meth)acrylate-based pressure sensitive adhesives. These materials have many desirable features such as frequently being inherently tacky and thus not requiring the use of added tackifying agents, they are typically formed by free radical polymerization to a high conversion, meaning that little or no un-polymerized monomer is left in the formed pressure sensitive adhesive, and a wide range of monomers can be used to form (meth)acrylate-based copolymers to tailor the desired properties of the pressure sensitive adhesive. Frequently the (meth)acrylate-based pressure sensitive adhesive is prepared from a reaction mixture that contains monomers with polar groups such as acidic and basic groups. Acidic and basic monomers are often classified in the adhesive art as reinforcing monomers, as these monomers tend to increase the cohesive strength of (meth)acrylate-based pressure sensitive adhesives. Therefore, preparing (meth)acrylate-based pressure sensitive adhesives that retain the requisite cohesive strength to be useful in medical applications without including polar reinforcing monomers is a challenge.

Another reason why acidic, basic or other polar groups are included in medical adhesives is to make the adhesives more hydrophilic to aid the moisture vapor transmission rate (MVTR) properties for long term wear. A wide variety of medical articles and devices are intended to remain adhered to the skin for extended periods of time. Current adhesive systems have difficulty remaining on the skin for extended periods of time because they suffer from moisture loading, that is to say, from moisture trapped between the skin and the adhesive layer because the adhesive has inadequate MVTR which results in “float off′’ of the system. MVTR is a measure of the passage of water vapor through a substance or barrier. Because perspiration naturally occurs on the skin, if the MVTR of a material or adhesive system is low, this can result in moisture accumulation between the skin and the adhesive that can cause the adhesive to “float of″ or peel away and also can promote other detrimental effects such as bacterial growth and skin irritation. Therefore, much work has focused upon the development of adhesive systems that have a high MVTR. Typically, the adhesive is designed to be hydrophillic, so that moisture from the skin will pass through the adhesive layer and not accumulate at the skin/adhesive interface. Since the adhesives are typically hydrocarbon-rich and therefore non-polar and hydrophobic, the adhesives typically inlcude polar groups such as acidic groups, basic groups or hydroxyl groups. Therefore, hydrocarbon-rich adhesives without polar groups are expected to have poor MVTR and thus poor long term wearability.

Another trend in the adhesive art is to prepare adhesives without using solvents. There are a variety of environmental and other reasons for eliminating solvent in the preparation of adhesive articles, but manufacturing adhesives, such as (meth)acrylate-based adhesives without using solvents can be problematic. Among the methods developed to prepare and coat adhesive systems are 100% solids systems, such as hot melt processable pressure sensitive adhesives. Difficulties have arisen when solvent processing has been replaced by hot melt processing. Often it is difficult to replicate the properties of solvent delivered adhesive layers with hot melt delivered systems.

Thus, among the desirable, and often contradictory, features desired for a medical adhesive include: high enough adhesion to attach to skin without causing skin damage upon removal; being free of polar groups such as acidic, basic, or hydroxyl groups, and yet have sufficiently high cohesive strength to be useful; have long term wearability; and be hot melt processable so that the use of solvents is not required.

Disclosed herein are adhesive compositions and adhesive articles that have the above desirable features. The adhesives disclosed herein are free of polar groups. One would anticipate that the lack of polar groups would result in poor MVTR and thus poor long term wearability, but it has been surprisingly found that this is not the case. As mentioned above, the lack of the polar groups reduces the cohesive strength of the adhesive matrix and also provides a very tacky adhesive matrix. The current adhesives compensate for the lack of cohesive strength and high tack through the use of branched and crosslinked matrices and with a high tackifier loading, which actually decreases the tackiness of the matrix. However, the non-polarity of adhesive matrix decreases the compatibility with many tackifier resins which are relatively polar and can form blends that have phase separation issues. Therefore, relatively non-polar tackifier resins such as hydrogenated hydrocarbon tackifier resins are used. The use of these non-polar tackifier resins permits relatively high loadings of tackifier resin without having phase separation. These hydrogenated hydrocarbon tackifier resins are generally not useful at high loading levels because they are not highly compatible with more polar adhesive matrices.

Disclosed herein are crosslinked adhesive compositions comprising a crosslinked (meth)acrylate-based copolymer free from polar groups, and a hydrogenated hydrocarbon tackifier resin. The crosslinked adhesive composition is the product of a hot melt processable blend of a (meth)acrylate copolymer and a hydrogenated hydrocarbon tackifier resin. The(meth)acrylate copolymer comprises the reaction product of a reaction mixture of at least one alkyl (meth)acrylate monomer with alkyl groups comprising 4-22 carbon atoms and are free of polar groups and a co-polymerizable photocrosslinker. The hot melt processed blend of the (meth)acrylate copolymer and a hydrogenated hydrocarbon tackifier resin photocrosslinked to form the crosslinked adhesive composition. Adhesive articles can be prepared by disposing this crosslinked adhesive composition on a substrate surface. The crosslinked adhesive composition is a hydrocarbon-rich and hydrophobic composition, and yet the adhesive provides good long term wearability.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. For example, reference to “a layer” encompasses embodiments having one, two or more layers. As used in this specification and the appended claims, the term “or” is generally employed in its sense including “and/or” unless the content clearly dictates otherwise.

The term “adhesive” as used herein refers to polymeric compositions useful to adhere together two adherends. Examples of adhesives are pressure sensitive adhesives.

Pressure sensitive adhesive compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power. Obtaining the proper balance of properties is not a simple process.

The term “(meth)acrylate” refers to monomeric acrylic or methacrylic esters of alcohols. Acrylate and methacrylate monomers or oligomers are referred to collectively herein as “(meth)acrylates”. Materials referred to as “(meth)acrylate-functional” are materials that contain one or more (meth)acrylate groups. Polymers described as “(meth)acrylate-based” contain at least a majority of (meth)acrylate monomers and can contain other co-polymerizable ethylenically unsaturated monomers.

The term “polar group” is used herein consistent with its common chemical usage. Among suitable polar groups in adhesive compositions are acidic groups, basic groups and hydroxyl groups.

The terms “room temperature” and “ambient temperature” are used interchangeably to mean temperatures in the range of 20° C. to 25° C.

The term “adjacent” as used herein when referring to two layers means that the two layers are in proximity with one another with no intervening open space between them. They may be in direct contact with one another (e.g. laminated together) or there may be intervening layers.

The term “polymer” is used herein consistently with the common usage in chemistry. Polymers are composed of many repeated subunits, the subunits may be the same (homopolymer) or they may be different (copolymer). The term “polymer” is used to describe the resultant material formed from a polymerization reaction.

The term “phr” refers to Parts per Hundred Resin, a measure used in the rubber industry (where it is usually described as parts per hundred rubber) to depict what amount of certain ingredients are needed, especially pre-vulcanization. The terms phr and parts by weight per 100 parts by weight of total monomers present in the reaction mixture are used interchangeably.

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The terms “free radically polymerizable” and “ethylenically unsaturated” are used interchangeably and refer to a reactive group which contains a carbon-carbon double bond which is able to be polymerized via a free radical polymerization mechanism.

The term “long term wearability” as used herein refers to the property of an adhesive article of being capable of attaching and remaining attached to mammalian skin for extended periods of time. The extended periods of time include 10 days, 20 days, 30 days and greater than 30 days. Long term wearable articles are also capable of removability from mammalian skin after the extended periods of time.

As used herein, the term “microstructure” means the configuration of features wherein at least 2 dimensions of the features are microscopic. The topical and/or cross-sectional view of the features must be microscopic.

As used herein, the term “microscopic” refers to features of small enough dimension so as to require an optic aid to the naked eye when viewed from any plane of view to determine its shape. One criterion is found in Modern Optic Engineering by W. J. Smith, McGraw-Hill, 1966, pages 104-105 whereby visual acuity, “... is defined and measured in terms of the angular size of the smallest character that can be recognized.” Normal visual acuity is considered to be when the smallest recognizable letter subtends an angular height of 5 minutes of arc on the retina. At typical working distance of 250 mm (10 inches), this yields a lateral dimension of 0.36 mm (0.0145 inch) for this object.

Disclosed herein are crosslinked adhesive compositions comprising a crosslinked (meth)acrylate-based copolymer free from polar groups, and a hydrogenated hydrocarbon tackifier resin. The crosslinked adhesive composition is the product of a hot melt processable blend of a (meth)acrylate copolymer and a hydrogenated hydrocarbon tackifier resin. The (meth)acrylate copolymer comprises the reaction product of a reaction mixture of at least one alkyl (meth)acrylate monomer with alkyl groups comprising 4-22 carbon atoms and is free of polar groups and a co-polymerizable photocrosslinker. The hot melt processed blend of the (meth)acrylate copolymer and a hydrogenated hydrocarbon tackifier resin is photocrosslinked to form the crosslinked adhesive composition.

The crosslinked adhesive composition is prepared by hot melt blending a crosslinkable (meth)acrylate copolymer and hydrogenated hydrocarbon tackifier resin, and photocrosslinking the (meth)acrylate copolymer. The crosslinkable (meth)acrylate copolymer is free from polar groups such as acidic, basic, or hydroxyl groups. The crosslinkable (meth)acrylate copolymer is prepared from a reaction mixture that comprises at least one alkyl (meth)acrylate monomer with an alkyl group comprising 4-22 carbon atoms and is free from polar groups, and a copolymerizable photocrosslinker. The reaction mixture also comprises a free radical initiator. In some embodiments, the reaction mixture may comprise additional (meth)acrylate monomers or other free radically polymerizable monomers, and may contain additional components such as multifunctional (meth)acrylates, and chain transfer agents. The reaction mixture typically comprises as the polymerizable components, at least one (meth)acrylate monomer and a co-polymerizable photocrosslinker. Each of these components is described in greater detail below.

The reaction mixture comprises at least one (meth)acrylate monomer of general formula I:

$${\text{CH}}_{2} = {\text{CR}}^{1} - \left(\text{CO}\right) - {\text{OR}}^{2}$$

wherein R¹ is hydrogen or a methyl group, and R² is an alkyl, with 4-22 carbon atoms.

Suitable alkyl (meth)acrylate monomers include, but are not limited to, those selected from the group consisting of the esters of acrylic acid or methacrylic acid with non-tertiary alkyl alcohols such as 1-butanol, 1-pentanol, 2-pentanol, 3-pentanol, 2-methyl-1-butanol, 1-methyl-1-butanol, 1-methyl-1-pentanol, 2-methyl-1-pentanol, 3-methyl-1-pentanol, 2-ethyl-1-butanol, 2-ethyl-1-hexanol, 3,5,5-trimethyl-1-hexanol, 3-heptanol, 2-octanol, 1-decanol, 1-dodecanol, and the like, and mixtures thereof. Such monomeric acrylic or methacrylic esters are known in the art and are commercially available.

In some embodiments, the alkyl(meth)acrylate monomer with alkyl groups comprising 8-18 carbon atoms. Examples of particularly suitable alkyl acrylate monomers are isooctyl acrylate, 2-ethylhexyl acrylate, lauryl acrylate, stearyl acrylate (also called octadecyl acrylate), dodecyl acrylate and mixtures thereof.

The reaction mixture that forms the (meth)acrylate-based copolymer also comprises a co-polymerizable photocrosslinker. Co-polymerizable photocrosslinkers are materials that contain a free radically polymerizable group to co-polymerize with the monomers described above. The co-polymerizable photocrosslinkers also contain a photosensitive group that upon exposure to the right wavelength of light, typically high intensity ultra-violet (UV) radiation, the photosensitive group forms free radicals which can form crosslinks in the polymer. If the (meth)acrylate-based polymer is formed by the use of a photoinitiator, the photocrosslinker is not activated by the same wavelengths of light as the photoinitiator. In this way, the co-polymerizable photocrosslinker is incorporated into the polymer, and is able to be thermally processed, as the crosslinker is thermally stable and remains intact until activated by the proper wavelength of light. This permits the co-polymerizable photocrosslinker to be activated after the polymer has been hot melt coated. The coated crosslinkable pressure sensitive adhesive layer is subjected to exposure to high intensity UV lamps to effect crosslinking. Examples of suitable UV lamps include medium pressure mercury lamps or a UV blacklight.

Suitable photocrosslinkers are the mono-ethylenically unsaturated aromatic ketone co-monomers that are free of ortho-aromatic hydroxyl groups such as those described in U.S. Pat. No. 4,737,559 (Kellen et al.). Specific examples include para-acryloxybenzophenone (ABP), para-acrylyoxyethoxybenzophenone, para-N-(methylacryloxyethyl)-carbamoylethoxybenzophenone, para-acryloxyacetophenone, ortho-acrylamidoacetophenone, acrylated anthraquinones, and the like. Particularly suitable is ABP para-acryloxybenzophenone also called 4-acryloxybenzophenone.

Typically, such photocrosslinkers are used in amounts of about 0.05-0.50 phr. The term phr means Parts per Hundred Resin, a measure used in the rubber industry (where it is usually described as parts per hundred rubber) to depict what amount of certain ingredients are needed, especially pre-vulcanization. In this case, the term phr refers to the parts by weight of photocrosslinker per 100 parts by weight of total monomers present in the reaction mixture. In some embodiments, the photocrosslinker is present in amounts of about 0.10 parts by weight of crosslinker per 100 parts by weight of total monomers present in the reaction mixture.

The reaction mixture that forms the crosslinkable (meth)acrylate copolymer may also comprise at least one difunctional (meth)acrylate monomer. Difunctional (meth)acrylates are well known as crosslinking agents for (meth)acrylate copolymers, but in the reaction mixture the amounts of difunctional (meth)acrylate is kept low so as to not to form a highly crosslinked network, but rather to increase the molecular weight and in some instances to provide branching. Typically, the difunctional (meth)acrylate monomer is present in the reaction mixture in an amount of 0.01-1.00 phr. One particularly suitable difunctional (meth)acrylate is HDDA (hexane diol diacrylate).

The reaction mixture that forms the crosslinkable (meth)acrylate copolymer may also comprise a free radical chain transfer agent, often referred to simply as a chain transfer agent. Examples of useful chain transfer agents include, but are not limited to, those selected from the group consisting of carbon tetrabromide, mercaptans, alcohols, and mixtures thereof. A particularly suitable chain transfer agent is IOTG (isooctyl thioglycolate). Chain transfer agents and the use of chain transfer agents is well understood in the adhesive arts. Typically, the chain transfer agent is present in the reaction mixture in an amount of 0.05-0.50 phr.

One way to increase molecular weight is to incorporate polymer branching with the addition of both difunctional (meth)acrylate comonomers (e.g. 1,6-Hexanediol diacrylate, or HDDA) and a free radical chain transfer agent (e.g. Iso-Octyl Thioglycolate, or IOTG).

The reaction mixture also comprises at least one initiator. Typically, the initiator is a photoinitiator, meaning that the initiator is activated by light, typically ultraviolet (UV) light. Photoinitiators are well understood by one of skill in the art of (meth)acrylate polymerization. Examples of suitable free radical photoinitiators include DAROCURE 1173, DAROCURE 4265, IRGACURE 184, IRGACURE 651, IRGACURE 1173, IRGACURE 819, LUCIRIN TPO, LUCIRIN TPO-L, commercially available from BASF, Charlotte, NC. The photoinitiator DAROCURE 1173 is particularly suitable.

Generally, the photoinitiator is used in amounts of 0.01 to 2 parts by weight, more typically 0.1 to 0.5, parts by weight relative to 100 parts by weight of total reactive components.

The crosslinkable (meth)acrylate copolymer can be prepared by a variety of different polymerization methods. Among the polymerization techniques include solvent borne polymerization, waterborne polymerization, or 100% solids polymerization. Among the 100% solids polymerization methods are bulk polymerization methods and polymerization in a package. All of these methods are well known in the polymer art.

In some embodiments, the crosslinkable (meth)acrylate copolymer is prepared in a thermoplastic package. This method is particularly suitable for hot melt processing, as the packages can be fed into a hot melt processing apparatus such as an extruder, and hot melt blended. Methods for preparing hot melt processable packaged adhesive compositions are described in U.S. Pat. No. 5,804,610 (Hamer et al.). The hot melt processable packaged adhesive compositions of this disclosure comprise a crosslinkable (meth)acrylate copolymer formed from a polymerizable pre-adhesive reaction mixture, and a packaging material. These pre-adhesive reaction mixtures are substantially free of polar monomers and have been described above. The pre-adhesive reaction mixture typically comprises, at least one alkyl (meth)acrylate monomer, a co-polymerizable photocrosslinker, and at least one initiator. In some embodiments, the pre-adhesive composition contains other components such as a chain transfer agent and/or a di-functional (meth)acrylate. Each of these components is described in greater detail above.

As mentioned above, the crosslinked pressure sensitive adhesive comprises a crosslinked (meth)acrylate-based copolymer as described above and further comprises at least one hydrogenated hydrocarbon tackifier resin. The hydrogenated hydrocarbon tackifier resin is substantially free of unsaturated groups and also is free of polar groups. A wide range of hydrogenated hydrocarbon tackifier resins are suitable. Among the suitable resins are those available from Aquent Impex under the trade names ES300, ES320, ES340, ES 380, ES600, and ES615and those from Arakawa Chemical under the ARKON trade name such as ARKON M-100, ARKON M-115, ARKON M-135, ARKON M-90, ARKON P-100, ARKON P-115, ARKON P-125, ARKON P-140, ARKON P-90, and ARKON P-70. Also suitable are those from Eastman Chemical Company under the REGALREZ and REGALITE trade names such as REGALREZ 1085, REGALREZ 1094, REGALREZ 3102, REGALREZ 1126, REGALREZ 1139, REGALREZ 6108, REGALITE S1100, REGALITE S5100, REGALITE R7100, REGALITE R9010 and REGALITE R9100.

The hydrogenated hydrocarbon tackifier resins are hot melt blended with the crosslinkable (meth)acrylate-based copolymer and disposed onto a surface to form an adhesive layer. The adhesive layer is then crosslinked by exposure to UV light to form a crosslinked pressure sensitive adhesive layer. Typically, the crosslinked pressure sensitive adhesive layer comprises less than 50% by weight hydrogenated hydrocarbon tackifier resin. In some embodiments, the crosslinked adhesive composition comprises 10-40% by weight hydrogenated hydrocarbon tackifier resin.

Since the tackifier resin, like the crosslinked (meth)acrylate-based copolymer, is hydrocarbon-based and free of polar groups, the crosslinked pressure sensitive adhesive layer is very hydrophobic and thus according to the conventional logic of medical adhesives, is anticipated to have very poor MVTR and therefore to have poor long term wearability. However, as will be discussed below, the crosslinked pressure sensitive adhesive layers of this disclosure have good long term wearability.

The crosslinked pressure sensitive adhesive layer may be of any suitable thickness, depending upon the desired use. In some embodiments, the thickness will be at least 10 micrometers, up to 2 millimeters, and in some embodiments the thickness will be at least 20 micrometers up to 1 millimeter thick. A wide range of intermediate thicknesses are also suitable, such as 25-500 micrometers, 200-400 micrometers, and the like.

Besides the crosslinked (meth)acrylate-based copolymer and hydrogenated hydrocarbon tackifier resin, the crosslinked pressure sensitive adhesive layer may further comprise one or more additives. A wide variety of additives are suitable as long as the additives do not hinder the utility of the pressure sensitive adhesive layer in medical articles. The additives can be added to the reaction mixture as long as the additives do not interfere with the polymerization reaction. Additionally, additives can be added to the (meth)acrylate-based copolymer during hot melt processing.

As mentioned above, in embodiments where the (meth)acrylate-based copolymer is polymerized within a package, the package containing crosslinkable (meth)acrylate-based copolymer is placed into a hot melt extruder and ground up, mixed with hydrogenated hydrocarbon tackifier resin, coated onto a substrate, and crosslinked to form the crosslinked pressure sensitive adhesive layer. One artifact of this process is that hot melt processing of the packaged (meth)acrylate copolymer generates particles of the packaging material in the crosslinked pressure sensitive adhesive layer. Therefore, in many embodiments, the crosslinked pressure sensitive adhesive further comprises particles formed from the packaging material which is a thermoplastic polymer. A wide variety of thermoplastic polymers are suitable. Examples of suitable thermoplastic polymers include polyethylene, ethylene vinyl acetate, ethylene methyl acrylate, ethylene acrylic acid, ethylene acrylic acid ionomers, polypropylene, acrylic polymers, polyphenylene ether, polyphenylene sulfide, acrylonitrile-butadiene-styrene copolymers, polyurethanes, and mixtures and blends thereof.

Examples of other suitable optional additives that can be included in the crosslinked pressure sensitive adhesive layer include plasticizers, anti-oxidants, fillers, leveling agents, ultraviolet light absorbers, hindered amine light stabilizers (HALS), oxygen inhibitors, wetting agents, rheology modifiers, defoamers, biocides, dyes, pigments, and the like. All of these additives and the use thereof are well known in the art. It is understood that any of these compounds can be used so long as they do not deleteriously affect the adhesive properties.

Also disclosed herein are adhesive articles. The adhesive articles have long term wearability. In this case, long term wearability means that the adhesive article is capable of attachment to mammalian skin for at least 10 days. In some embodiments, the adhesive articles are capable of attachment to mammalian skin for at least 20 days, 30 days or even longer times. The adhesive articles comprise a substrate comprising a first major surface and a second major surface, and a crosslinked adhesive layer with a first major surface and a second major surface where the first major surface of the adhesive layer is at least partially disposed on the second major surface of the substrate. The crosslinked adhesive layer has been described above. Typically, the crosslinked adhesive layer comprises a crosslinked adhesive composition comprising a crosslinked (meth)acrylate-based copolymer free from polar groups, and a hydrogenated hydrocarbon tackifier resin. As described above, the crosslinked adhesive composition is the product of a hot melt processable blend of a crosslinkable (meth)acrylate copolymer and a hydrogenated hydrocarbon tackifier resin. The crosslinkable (meth)acrylate copolymer is the reaction product of a reaction mixture comprising at least one alkyl (meth)acrylate monomer with alkyl groups comprising 4-22 carbon atoms and are free of polar groups, and a co-polymerizable photocrosslinker. Typically, the reaction mixture also comprises a photoinitiator and may include difunctional (meth)acrylate comonomers (e.g. 1,6-Hexanediol diacrylate, or HDDA) and/or a free radical chain transfer agent (e.g. Iso-Octyl Thioglycolate, or IOTG) as described above.

As described above, in some embodiments, the crosslinkable (meth)acrylate copolymer is prepared in a thermoplastic package, the packaged copolymers are hot melt blended with the hydrogenated hydrocarbon tackifier resin, the hot melt blend is disposed on the substrate surface to form an adhesive layer, and the adhesive layer is crosslinked to form the crosslinked (meth)acrylate-based pressure sensitive adhesive layer.

In some embodiments, the second major surface of the crosslinked adhesive layer comprises a structured surface, typically a microstructured surface.

The microstructures can be imparted to the adhesive layer in a variety of different ways. Typically, either an adhesive composition is applied to a microstructured surface to form a microstructured adhesive layer. A substrate can be contacted to this microstructured adhesive layer to form an adhesive article. Another method for imparting the microstructured adhesive layer is contact the adhesive composition to the substrate surface to form an adhesive layer and then contacting this adhesive layer to a microstructured surface. Each method has advantages and disadvantages. In the case of crosslinked microstructured adhesive layers, typically it is desirable to effect crosslinking of the adhesive while in contact with the microstructured surface such that the adhesive is crosslinked in the microstructured state. In this way the microstructures become essentially permanent. If the crosslinked pressure sensitive adhesive is contacted to a microstructured surface, upon removal of the microstructured surface the microstructures are non-permanent.

The adhesive composition can be applied to a microstructured surface, such as a microstructured release liner or microstructured tool, by any conventional application method, including, but not limited to, extrusion coating, gravure coating, curtain coating, slot coating, spin coating, screen coating, transfer coating, brush or roller coating, and the like. The adhesive composition can be applied to the microstructured surface as a hot melt composition, a solvent-borne composition or a 100% solids composition. The adhesive layer coating can be further processed to produce the adhesive layer. The processing can include drying of the adhesive layer coating if solvent-borne, cooling of the adhesive layer coating if hot melt coated, or crosslinking of the adhesive layer. Crosslinking, if desired, can be effected by the application of heat or radiation or a combination thereof. The thickness of a coated adhesive layer, typically in the form of a liquid is in part dependent on the nature of the materials used and the specific properties desired, but those properties and the relationship of thickness to the properties is well understood in the art. Exemplary thicknesses of an adhesive layer may be in the range from about 0.05 to about 100 micrometers.

Typically, a microstructured release liner is used to impart the microstructured pattern in the adhesive layer, since release liners remain with the adhesive layer during shipment and processing and are only removed when the adhesive article is to be used. In this way, the adhesive layer is protected until the article is to be used. A wide range of microstructured release liners are suitable. Typically, the microstructured release liners are prepared by embossing. This means that the release liner has an embossable surface which is contacted to a structured tool with the application of pressure and/or heat to form an embossed surface. This embossed surface is a structured surface. The structure on the embossed surface is the inverse of the structure on the tool surface, that is to say a protrusion on the tool surface will form a depression on the embossed surface, and a depression on the tool surface will form a protrusion on the embossed surface.

A wide variety of patterns and shapes can be present in the surface of the microstructured surface of the release liner. The shape or pattern of the structures does not matter if the pattern is pre-embossed into the release liner surface prior to contacting the adhesive layer or if the structure is imparted to the release liner surface by embossing through the release liner when the release liner is in contact with the adhesive layer. The structures may have a wide variety of shapes and sizes. In general, the structures are microstructures, meaning that they are microstructural features with at least 2 dimensions of the structures of microscopic size. The microstructural features may assume a variety of shapes. Representative examples include hemispheres, prisms (such as square prisms, rectangular prisms, cylindrical prisms and other similar polygonal features), pyramids, ellipses, grooves (e.g., V-grooves), channels, and the like. In general, it is desirable to include topographical features that promote air egress at the bonding interface when the adhesive layer is laminated to an adherend. In this regard, V-grooves and channels that extend to the edge of the article are particularly useful. The particular dimensions and patterns characterizing the microstructural features are selected based upon the specific application for which the article is intended.

A wide range of substrates are suitable for use in the adhesive articles of this disclosure. As is described below, the substrate may be a monolithic construction or a multi-layer construction. In the multi-layer constructions, the substrate may have a variety of coatings or layers present either adjacent to or as the first or second surface of the substrate.

A wide range of substrates are suitable, including release liners, and medical substrates. Release liners are sheet materials that have a low adhesion coating on at least one surface. The hot melt processable pressure sensitive adhesives of the present disclosure can be disposed on a release liner to generate an article comprising a layer of pressure sensitive adhesive on a release liner. This adhesive/release liner article can be used to prepare other adhesive/substrate articles by laminating the adhesive layer to a different substrate and then removing the release liner. This permits the adhesive to be disposed onto substrates to which it is difficult to directly dispose the hot melt processable pressure sensitive adhesive, such as substrates that are thermally sensitive. The adhesive/release liner article may also be used to apply the pressure sensitive adhesive layer to an article such as, for example, an electrode, an ostomy device, or the like.

Exemplary medical substrates include polymeric materials, plastics, natural macromolecular materials (e.g., collagen, wood, cork, silk, and leather), paper, cloth, fabrics, non-wovens, metals, glass, ceramics, composites, and combinations thereof. The medical substrate may be a tape backing. Examples of suitable tape backings include breathable conformable backing, on which the adhesive is disposed. A wide range of breathable conformable backings are suitable for use in articles of this disclosure. Typically, the breathable conformable backing comprises a woven or knit textile, a nonwoven, or a plastic.

In some embodiments, the breathable conformable backing comprises a high moisture vapor permeable film backing. Examples of such backings, methods of making such films, and methods for testing their permeability are described, for example, in U.S. Pat. Nos. 3,645,835 and 4,595,001. Typically, such backings are porous materials.

Generally, the backing is conformable to anatomical surfaces. As such, when the backing is applied to an anatomical surface, it conforms to the surface even when the surface is moved. Generally, the backing is also conformable to animal anatomical joints. When the joint is flexed and then returned to its unflexed position, the backing stretches to accommodate the flexion of the joint, but is resilient enough to continue to conform to the joint when the joint is returned to its unflexed condition.

Examples of particularly suitable backings can be found in U.S. Pat. Nos. 5,088,483 and 5,160,315, and include elastomeric polyurethane, polyester, or polyether block amide films. These films have a combination of desirable properties including resiliency, high moisture vapor permeability, and transparency.

The articles may include additional optional layers. In some embodiments, it may be desirable for there to be a primer layer between the substrate surface and the pressure sensitive adhesive layer. Generally, the primer layer comprises materials that are commonly referred to as “primers” or “adhesion promoters”. Primers and adhesion promoters are materials that are applied as thin coatings on a surface and strongly adhere to the surface and provide a modified surface chemistry to the surface. Examples of suitable coating materials include polyamides, poly(meth)acrylates, chlorinated polyolefins, rubbers, chlorinated rubbers, polyurethanes, siloxanes, silanes, polyester, epoxies, polycarbodiimides, phenolics, and combinations thereof. Typically, the articles of this disclosure do not require primer layers since, when the hot melt processable pressure sensitive adhesives is disposed on the substrate surface it tends to form strong interactions with a wide range of substrate surfaces, making primers unnecessary.

In some embodiments, it may be desirable that the first major surface of the substrate, that is to say the surface on which the adhesive construction is not coated, have a low adhesion coating. This is especially true if the adhesive article is to be supplied in the form of a tape. Many tapes are supplied as rolls, where the adhesive layer contacts the non-adhesive “back” side of the backing upon being rolled up. Often this non-adhesive surface of the backing has a low adhesion or release coating on it to permit the roll to be unwound. These low adhesion coatings are often called “low adhesion backsizes” or LABs. Many factors control whether an LAB coating is necessary or desirable, including the nature of the adhesive, the composition and topography of the backing, and the desired use for the tape article.

### EXAMPLES

These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Sigma-Aldrich Chemical Company; Milwaukee, Wisconsin unless otherwise noted. The following abbreviations are used: cm = centimeters; mm = millimeters; RPM = revolutions per minute; mW = milliWatts; mJ = milliJoules; FPM = feet per minute; MPM = meters per minute. The term “phr”, refers to parts by weight per 100 parts by weight of the (meth)acrylate monomer.

Table of Abbreviations

| | | |
|---|---|---|
| Material | Reference or description | Source (Location) |
| Dodecyl acrylate isomer blend | DAIB | DAIB synthesized according to U.S. Pat. No. 9,102,774 (Clapper et al.). |
| Acrylic acid | AA | BASF (Florham Park, NJ) |
| IRGACURE 1173 | Photoinitiator | BASF (Florham Park, NJ) |
| 4-Acryloyloxybenzophenone | ABP | ABP synthesized according to U.S. Pat. No. 4,737,559 (Kellen et al.). |
| Isooctylthioglycolate | IOTG | Arkema (King of Prussia, PA) |
| 1,6-Hexanediol diacrylate | HDDA | Arkema (King of Prussia, PA) |
| IRGANOX 1076 | Antioxidant | BASF (Florham Park, NJ) |
| Fully hydrogenated hydrocarbon tackifier “ARKON P125” | TACK-1 | Arakawa Chemical USA (Chicago, IL) |
| Fully hydrogenated hydrocarbon tackifier “ARKON P140” | TACK-2 | Arakawa Chemical USA (Chicago, IL) |

### Procedures and Test Methods

### Bulk Photopolymerization

Formulations for acrylate base polymers were made according to the methods described in U.S. Pat. No. 6,294,249 (Hamer et al.).

### Hot Melt Coating Process

The packaged acrylate base polymers were blended with tackifiers in a twin-screw extruder at a temperature ranging from 145-180° C. and a screw speed at 300 rpm. The blended adhesive mixtures were coated onto a paper release liner through a contact die at a desired film thickness in a range of 25-150 micrometers.

### UV Curing Process

The coated adhesive films were cured through either a) an in-line or b) an off-line UV crosslinking process. a) For in-line curing, the coated adhesive films were annealed in an in-line oven at 200° F. (93° C.) for 20 seconds at a line speed of 3 fpm (0.9 mpm), and cured in an in-line UV station with a UVC dosage of 50 mJ/cm². b) For off-line curing, the coated adhesive films were annealed in a bench oven at 200° F. (93° C.) for 10 minutes and cured in an off-line UV station with a UVC dosage of 50 mJ/cm².

### Wearability Test Method

Sample dressings for testing were prepared by hand-laminating UV cured adhesives to melt-blown nonwoven polyurethane medical tape backing (CoTran 9700, 3M Company, St. Paul, MN) with desired thickness as listed in Table 2. The laminates were die-cut into 33 mm-square patches with rounded corners. Acrylic plates, 1.6 mm-thick and 29 mm-square with rounded corners, were adhered to the center of the patches using 3M Medical Tape 9889 (3M Company, St. Paul, MN) die-cut to the same dimensions as the plates.

Wearability studies consisted of two male volunteers wearing samples on the backs of their arms. The only restriction on activities was no swimming or other prolonged immersion of the samples. No precautions were taken to keep the samples dry during exercise or while showering. The Wear Times reported in Table 2 are the day samples fell off. If a sample remained adhered 45 days after application, it was removed that day.

Most samples were worn in duplicate by a single volunteer on right and left arms. Large variances in wear time for equivalent samples (15 and 26 days for Examples 3 and 4, respectively) were associated with poor placement of samples on the arm, resulting in early failure of one of the two samples.

### EXAMPLES

### Example 1

The base polymer was formulated with 100 parts of DAIB, 0.2 parts per hundred resin (phr) of Photinitiator, 0.065 phr of ABP, 0.04 phr of IOTG, 0.03 phr of HDDA and 0.4 phr of Antioxidant using the bulk photopolymerization procedure provided above. The as-prepared base polymer was blended with TACK-1 at a mass ratio of 85 to 15 and this blend was extruded onto a paper release liner using the hot-melt coating process above. The extruded adhesive film was then UV cured in-line. The cured adhesive was then tested according to the wearability test method described above.

### Example 2

The base polymer was formulated with 100 parts of DAIB, 0.2 phr of Photinitiator, 0.065 phr of ABP, 0.04 phr of IOTG, 0.03 phr of HDDA and 0.4 phr of Antioxidant using the bulk photopolymerization procedure provided above. The as-prepared polymer was blended with TACK-1 at a mass ratio of 80 to 20 and this blend was extruded onto a paper release liner using the hot-melt coating process above. The extruded adhesive film was then UV cured offline. The cured adhesive was then tested according to the wearability test method described above.

### Example 3

The base polymer was formulated with 100 parts of DAIB, 0.2 phr of Photinitiator, 0.065 phr of ABP, 0.04 phr of IOTG, 0.03 phr of HDDA and 0.4 phr of Antioxidant using the bulk photopolymerization procedure provided above. The as-prepared polymer was blended with TACK-1 at a mass ratio of 70 to 30 and this blend was extruded onto a paper release liner using the hot-melt coating process above. The extruded adhesive film was then UV cured offline. The cured adhesive was then tested according to the wearability test method described above.

### Example 4

The base polymer was formulated with 100 parts of DAIB, 0.2 phr of Photinitiator, 0.065 phr of ABP, 0.04 phr of IOTG, 0.03 phr of HDDA and 0.4 phr of Antioxidant using the bulk photopolymerization procedure provided above. The as-prepared polymer was blended with TACK-1 at a mass ratio of 65 to 35 and this blend was extruded onto a paper release liner using the hot-melt coating process above. The extruded adhesive film was then UV cured offline. The cured adhesive was then tested according to the wearability test method described above.

### Example 5

The base polymer was formulated with 100 parts of DAIB, 0.2 phr of Photinitiator, 0.065 phr of ABP, 0.05 phr of IOTG, 0.032 phr of HDDA and 0.4 phr of Antioxidant using the bulk photopolymerization procedure provided above. The as-prepared polymer was blended with TACK-1 at a mass ratio of 65 to 35 and this blend was extruded onto a paper release liner using the hot-melt coating process above. The extruded adhesive film was then UV cured offline. The cured adhesive was then tested according to the wearability test method described above.

### Example 6

The base polymer was formulated with 100 parts of DAIB, 0.2 phr of Photinitiator, 0.065 phr of ABP, 0.05 phr of IOTG, 0.032 phr of HDDA and 0.4 phr of Antioxidant using the bulk photopolymerization procedure provided above. The as-prepared polymer was blended with TACK-2 at a mass ratio of 65 to 35 and this blend was extruded onto a paper release liner using the hot-melt coating process above. The extruded adhesive film was then UV cured offline. The cured adhesive was then tested according to the wearability test method described above.

### Comparative Example 1

The base polymer was formulated with 98 parts of DAIB, 2 parts of AA, 0.2 phr of Photinitiator, 0.05 phr of ABP, 0.06 phr of IOTG, 0.045 phr of HDDA and 0.4 phr of Antioxidant using the bulk photopolymerization procedure provided above. The as-prepared polymer was extruded onto a paper release liner using the hot-melt coating process above. The extruded adhesive film was then UV cured offline. The cured adhesive was then tested according to the wearability test method described above.

### Comparative Example 2

The base polymer was formulated with 98 parts of DAIB, 2 parts of AA, 0.2 phr of Photinitiator, 0.05 phr of ABP, 0.06 phr of IOTG, 0.045 phr of HDDA and 0.4 phr of Antioxidant using the bulk photopolymerization procedure provided above. The as-prepared polymer was blended with TACK-1 at a mass ratio of 80 to 20 and this blend was extruded onto a paper release liner using the hot-melt coating process above. The extruded adhesive film was then UV cured offline. The cured adhesive was then tested according to the wearability test method described above.

### Comparative Example 3

The base polymer was formulated with 98 parts of DAIB, 2 parts of AA, 0.2 phr of Photinitiator, 0.05 phr of ABP, 0.06 phr of IOTG, 0.054 phr of HDDA and 0.4 phr of Antioxidant using the bulk photopolymerization procedure provided above. The as-prepared polymer was blended with TACK-1 at a mass ratio of 90 to 10 and this blend was extruded onto a paper release liner using the hot-melt coating process above. The extruded adhesive film was then UV cured offline. The cured adhesive was then tested according to the wearability test method described above.

### Comparative Example 4

The base polymer was formulated with 98 parts of DAIB, 2 parts of AA, 0.2 phr of Photinitiator, 0.05 phr of ABP, 0.06 phr of IOTG, 0.054 phr of HDDA and 0.4 phr of Antioxidant using the bulk photopolymerization procedure provided above. The as-prepared polymer was blended with TACK-1 at a mass ratio of 90 to 10 and this blend was extruded onto a paper release liner using the hot-melt coating process above. The extruded adhesive film was then UV cured offline. The cured adhesive was then tested according to the wearability test method described above.

TABLE 1

DAIB base polymer formulations (all values are parts by weight)

| | DAIB | AA | Photoinitiator | ABP | IOTG | HDDA | Antioxidant |
|---|---|---|---|---|---|---|---|
| Example 1 | 100 | | 0.2 | 0.065 | 0.04 | 0.03 | 0.4 |
| Example 2 | 100 | | 0.2 | 0.065 | 0.04 | 0.03 | 0.4 |
| Example 3 | 100 | | 0.2 | 0.065 | 0.04 | 0.03 | 0.4 |
| Example 4 | 100 | | 0.2 | 0.065 | 0.05 | 0.032 | 0.4 |
| Example 5 | 100 | | 0.2 | 0.065 | 0.05 | 0.032 | 0.4 |
| Comparative Example 1 | 98 | 2 | 0.2 | 0.05 | 0.06 | 0.045 | 0.4 |
| Comparative Example 2 | 98 | 2 | 0.2 | 0.05 | 0.06 | 0.045 | 0.4 |
| Comparative Example 3 | 96 | 4 | 0.2 | 0.05 | 0.06 | 0.045 | 0.4 |
| Comparative Example 4 | 96 | 4 | 0.2 | 0.05 | 0.06 | 0.045 | 0.4 |

TABLE 2

DAIB base polymer/tackifier adhesive composition weight ratios, thickness of extruded adhesive films, and wear times

| | DAIB Base Polymer | TACK-1 | TACK-2 | Adhesive Thickness in micrometers (mils) | Wear Time (days) |
|---|---|---|---|---|---|
| Example 1 | 85 | 15 | ---- | 100(4) | 11/12 |
| Example 2 | 80 | 20 | ---- | 100(4) | 45/45 |
| Example 3 | 70 | 30 | ---- | 100(4) | 45/38 |
| Example 4 | 65 | 35 | ---- | 100(4) | 30/45 |
| Example 5 | 65 | 35 | ---- | 100(4) | 12/38 |
| Example 6 | 65 | | 35 | 100(4) | 12/16 |
| Comparative Example 1 | 100 | | ---- | 100(4) | 8/9 |
| Comparative Example 2 | 80 | 20 | ---- | 100(4) | 22/27 |
| Comparative Example 3 | 90 | 10 | ---- | 100(4) | 12 |
| Comparative Example 4 | 90 | 10 | ---- | 50 (2) | 5 |

What is claimed is:

1. A crosslinked adhesive composition comprising:
a crosslinked (meth)acrylate-based copolymer free from polar groups; and
a hydrogenated hydrocarbon tackifier resin,
wherein the crosslinked adhesive composition is the product of a hot melt processable
blend of:
a (meth)acrylate copolymer comprising the reaction product of a reaction mixture comprising:
at least one alkyl (meth)acrylate monomer with alkyl groups comprising 4-22 carbon atoms and are free of polar groups; and
a co-polymerizable photocrosslinker; and
a hydrogenated hydrocarbon tackifier resin;
wherein the hot melt processed blend has been photocrosslinked.

2. The crosslinked adhesive composition of claim 1, wherein the crosslinked adhesive composition comprises less than 50% by weight hydrogenated hydrocarbon tackifier resin.

3. The crosslinked adhesive composition of claim 1, wherein the crosslinked adhesive composition comprises 10-40% by weight hydrogenated hydrocarbon tackifier resin.

4. The crosslinked adhesive composition of claim 1, wherein the at least one alkyl (meth)acrylate monomer with alkyl groups comprising 8-18 carbon atoms.

5. The crosslinked adhesive composition of claim 1, wherein the reaction mixture further comprises at least one difunctional (meth)acrylate monomer.

6. The crosslinked adhesive composition of claim 5, wherein the difunctional (meth)acrylate monomer comprises 0.01-1.00 phr of the reaction mixture.

7. The crosslinked adhesive composition of claim 1, wherein the reaction mixture comprises 0.05-0.50 phr of photocrosslinker.

8. The crosslinked adhesive composition of claim 1, wherein the reaction mixture comprises 0.05-0.50 phr of chain transfer agent.

9. The crosslinked adhesive composition of claim 1, wherein the crosslinked adhesive composition further comprises particles of thermoplastic polymer.

10. The crosslinked adhesive composition of claim 9, wherein the hot melt processable blend comprises a packaged composition comprising a thermoplastic package surrounding the reaction mixture, and wherein the particles of thermoplastic polymer comprise the residue of the packaging material.

11. An adhesive article comprising:
a substrate comprising a first major surface and a second major surface; and
a crosslinked adhesive layer with a first major surface and a second major surface wherein the first major surface of the adhesive layer is at least partially disposed on the second major surface of the substrate, wherein the crosslinked adhesive layer comprises a crosslinked adhesive composition comprising:
a crosslinked (meth)acrylate-based copolymer free from polar groups; and
a hydrogenated hydrocarbon tackifier resin,
wherein the crosslinked adhesive composition is the product of a hot melt processable blend of:
a (meth)acrylate copolymer comprising the reaction product of a reaction mixture comprising:
at least one alkyl (meth)acrylate monomer with alkyl groups comprising 4-22 carbon atoms and are free of polar groups; and
a co-polymerizable photocrosslinker; and
a hydrogenated hydrocarbon tackifier resin;
wherein the hot melt processed blend has been photocrosslinked, and
wherein the adhesive article is capable of attachment to mammalian skin for at least 10 days.

12. The adhesive article of claim 11, wherein second major surface of the crosslinked adhesive layer comprises a structured surface.

13. The adhesive article of claim 11, wherein the substrate comprises polymeric materials, plastics, natural macromolecular materials, paper, cloth, fabrics, non-wovens, metals, glass, ceramics, composites, and combinations thereof.

14. The adhesive article of claim 11, wherein the crosslinked adhesive composition comprises less than 50% by weight hydrogenated hydrocarbon tackifier resin.

15. The adhesive article of claim 11, wherein the crosslinked adhesive composition comprises 10-40% by weight hydrogenated hydrocarbon tackifier resin.

16. The adhesive article of claim 11, wherein the at least one alkyl (meth)acrylate monomer with alkyl groups comprising 8-18 carbon atoms.

17. The adhesive article of claim 11, wherein the reaction mixture further comprises at least one difunctional (meth)acrylate monomer, comprising 0.01-1.00 phr of the reaction mixture.

18. The adhesive article of claim 11, wherein the reaction mixture comprises 0.05-0.50 phr of photocrosslinker.

19. The adhesive article of claim 11, wherein the reaction mixture comprises 0.05-0.50 phr of chain transfer agent.

20. The adhesive article of claim 11, wherein the crosslinked adhesive composition further comprises particles of thermoplastic polymer.
